(19) United States
(12) Patent Application Publication
(10) Pub. No.: US 2007/0107000 A1
(43) Pub. Date: May 10, 2007

(54) Portable disk player

(75) Inventor: Juen Tien Peng, Taoyuan Hsien (TW)

Correspondence Address: HAMRE, SCHUMANN, MUELLER & LARSON, P.C., P.O. BOX 2902, MINNEAPOLIS, MN, 55402-0902, US

(73) Assignee: Action Technology (Shenzhen) Co., Ltd., Shenzhen (CN)

(21) Appl. No.: 11/268,144

(22) Filed: Nov. 7, 2005

(51) Int. Cl. G11B 33/02; G11B 17/04; G11B 17/03

(52) U.S. Cl. 720/600

(57) ABSTRACT

A portable disk player comprises: a base unit (1) defining a disk driven device and a disk read processing device therein, said base unit forming a mounting base (12) on a bottom cover (10) thereof, said mounting base including a protrusion (16); a display (2) being pivotally connected with one side of said base unit; and a connecting hinge (3) connecting said base unit with said display and including a horizontal tube (32) extending horizontally, a longitudinal tube (34) extending longitudinally, said longitudinal tube including a projection (342); wherein when said connecting hinge is located in a first position, one side of said projection of said longitudinal tube resists against one side of said protrusion of said mounting base, and when said connecting hinge is located in a second position, the other side of said projection of the longitudinal tube resists against the other side of said protrusion of said mounting base.

### BACKGROUND OF THE INVENTION

1. Field of the Invention

The present invention relates to a portable disk player, and more especially to a portable disk player enabling preferable visual effect in various direction.

2. Description of the Prior Art

Generally a known portable disk player includes a base unit defining a disk driven device and a disk read processing device, a display pivotable on one side of the base unit, and a cable connected between the base unit and the display. In use, by pivoting the display from a horizontal position to an inclined position, users can view contents recorded in the disk.

Under certain situation, because of limitation of space users hope the display to be turned to a suitable angle so as to obtain better visual effect. However, current disk players could not satisfy this requirement.

### BRIEF SUMMARY OF THE INVENTION

A primary object of the present invention is to provide a portable disk player enabling preferable visual effect in various direction.

To achieve the above-mentioned object, a portable disk player comprising: a base unit defining a disk driven device and a disk read processing device therein, said base unit forming a mounting base on a bottom cover thereof, said mounting base including a protrusion; a display being pivotally connected with one side of said base unit; and a connecting hinge connecting said base unit with said display and including a horizontal tube extending horizontally, a longitudinal tube extending longitudinally, said longitudinal tube including a projection; wherein when said connecting hinge is located in a first position, one side of said projection of said longitudinal tube resists against one side of said protrusion of said mounting base, and when said connecting hinge is located in a second position, the other side of said projection of the longitudinal tube resists against the other side of said protrusion of said mounting base.

In accordance with the present invention, the horizontal tube of the T-shaped connecting hinge above-mentioned is located on the display to ensure that the display can be rotated along the rotation axis of the horizontal tube. The longitudinal tube is located on the base unit to ensure that the display can be rotated along a rotation axis of the longitudinal tube. The projection and the protrusion located on the longitudinal tube and the bottom cover respectively can ensure that the rotation will cease after the display is turned to certain angle. In general it is convenient for users to adjust any position of the display so as to obtain preferred visual effect.

Other objects, advantages and novel features of the present invention will become more apparent from the following detailed description when taken in conjunction with the accompanying drawings, in which:

### BRIEF DESCRIPTION OF THE DRAWINGS

FIG. 1 is a perspective view of a portable disk player in accordance with the present invention showing a closed state;

FIG. 2 is a perspective view of the portable disk player of FIG. 1 when use;

FIG. 3 is a perspective view of a connecting hinge of the portable disk player of FIG. 1;

FIG. 4 is a partial perspective view of a bottom cover of the portable disk player of FIG. 1;

FIG. 5 is a cross-sectional view along line A-A of FIG. 1;

FIG. 6 is a cross-sectional view along line B-B of FIG. 1; and

FIG. 7 is a perspective view of a damper of the portable disk player of FIG. 1.

### DETAILED DESCRIPTION OF THE INVENTION

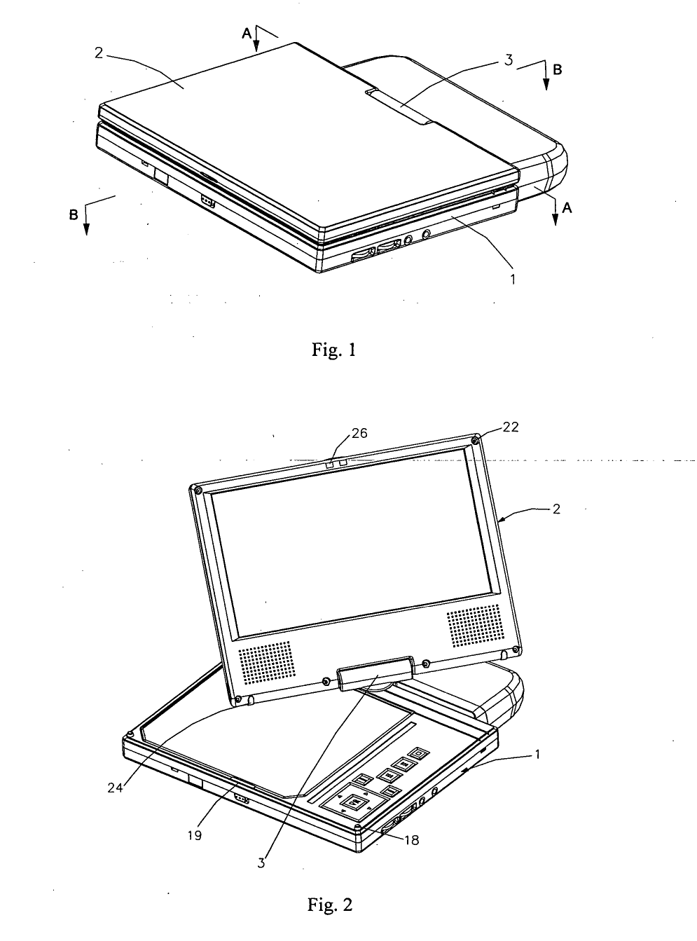

Referring to FIGS. 1-2, a portable disk player in accordance with a preferred embodiment of the present invention includes a base unit 1 and a displayer 2. The base unit 1 forms a disk driven device and a disk read processing device therein (not shown). The display 2 is pivotally connected with one side of the base unit 1. A connecting hinge 3 connects the base unit 1 with the display 2. In a closed state, the display 2 flatly rests on a surface of the base unit 1 while in a use state the display 2 is unfolded and can be rotated in a horizontal direction.

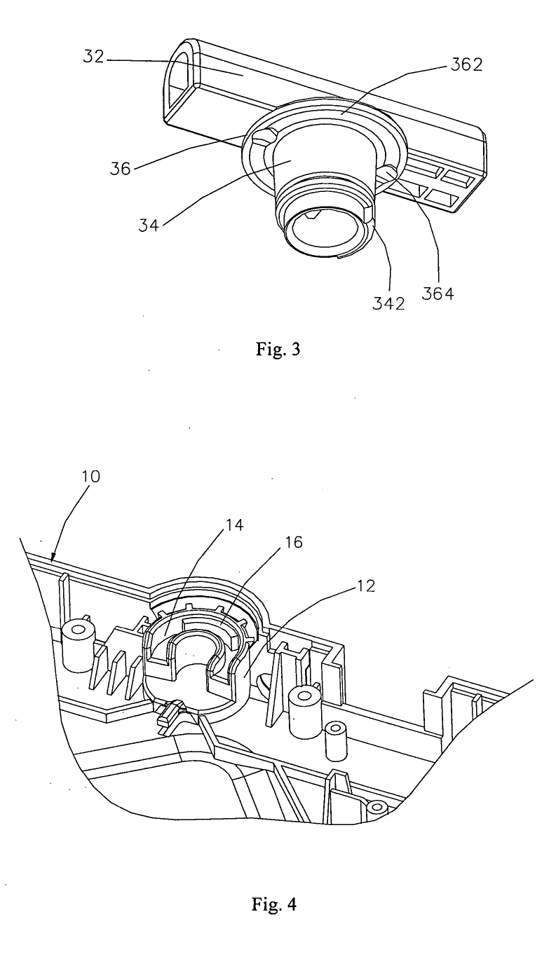

Referring to FIG. 3 together, an opening (not shown) in which the connecting hinge 3 is mounted is formed in a center of the conjunction where the display 2 is pivotally connected with the base unit 1. The connecting hinge 3 is a T-shaped hollow tube and includes a horizontal tube 32 extending horizontally, a longitudinal tube 34 extending longitudinally and a turnplate 36 located between the horizontal tube 32 and the longitudinal tube 34. The horizontal tube 32 is mounted in the opening above-mentioned. The longitudinal tube 34 is mounted on the base unit 1. A projection 342 extends radially from a free end of the longitudinal tube 34. The projection 342 is shaped as a quarter of a circle so as to engage with the base unit 1 to position during rotation of the display 2 (see later detailed description). A bottom of the turnplate 36 defines a circular slide rail 362 depressed downwardly therefrom and having a pit 364. There is a hard ball (not shown) on a surface of the base unit 1 corresponding to the position of the turnplate 36 which can roll in the slide rail 362 and can be locked within the pit 364. There is a large touch area between the slide rail 362 and the hard ball thereby increasing friction to facilitate rotation and position of the display 2. The hard ball is locked in the pit 364 when the display 2 turns to an ultimate position, which reminds the user to stop turning the display 2 so as to avoid damage to the display 2.

Then referring to FIG. 4, a bottom cover 10 of the base unit forms a mounting base 12 for mounting the longitudinal tube 34 of the connecting hinge 3. The mounting base 12 defines a recess 14 for insertion of the free end of the longitudinal tube 34 and a protrusion 16 projecting from the recess 14. The protrusion 16 is shaped as a quarter of a circle. The connecting hinge 3 can be rotated from the first position to the second position. In this embodiment an angle rotatable of the connecting hinge 3 is 180°. When the connecting hinge 3 is located in the first position, one side of the projection 342 of the longitudinal tube 34 resists against one side of the protrusion 16 of the mounting base 12, and when he connecting hinge 3 is located in the second position, the other side of the projection 342 of the longitudinal tube 34 resists against the other side of the protrusion 16 of the mounting base 12, so that the rotation of the display 2 will cease once reaching the first position and the second position. It should be understood that the projection 342 and the protrusion 16 can be designed as arcs with different length according to the angle ratatable of the display 2.

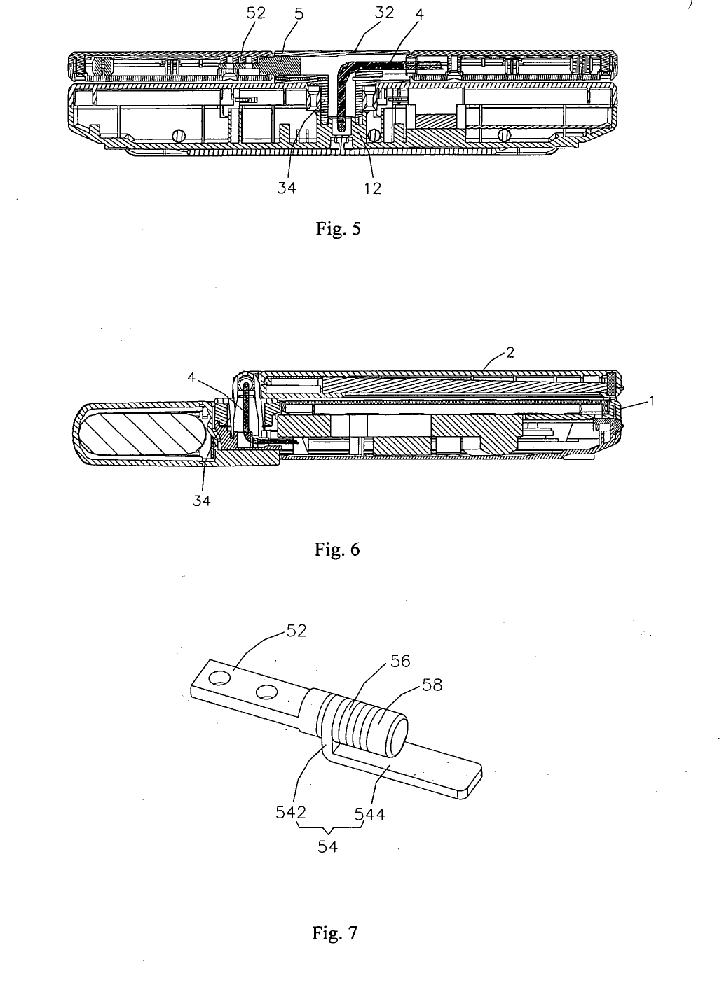

Referring to FIGS. 5-7, a cable 4 connects the base unit 1 and the display 2 across an inner of the connecting hinge 3. A damper 5 is formed on one end of the horizontal tube 32. The damper 5 includes an axis 52, a mounting sheet 54 for mounting the damper 5 into the connecting hinge 3, a plurality of damper sheets 56 and a nut 58. One end of the axis 52 is tabular and defines several through holes by which this end can be locked into the display 2. The mounting sheet 54, the damper sheets 56 and the nut 58 are hitched onto the other end of the axis 52 in turn and all of them are arranged in the horizontal tube 32 of the connecting hinge 3. The mounting sheet 54 is L-shaped and has a longitudinal sheet 542 extending longitudinally and a horizontal sheet 544 extending horizontally. The longitudinal sheet 542 is hitched onto the axis 52 and the horizontal sheet 544 is located in a lower portion in the horizontal tube 32 of the connecting hinge 3. Each damper sheet 56 is bent to an arc and defines a hole (not shown) therein. The shape and size of the hole are similar to the axis in corresponding position, that is, both are not circular and have a relative long diameter and a relative short diameter, which the damper 56 can be installed onto the axis 52 stably and turned accompanying with the axis 52. The nut 58 is a nylon nut of which one end of the screw thread has nylon material. In assembly, since the damper sheets 56 are impacted between the mounting sheet 54 and the nut 58 to make elastic deformation, there produce friction among the damper sheets 56 thereby ensuring any visual angle for the display 2. The amount of the damper sheets 56 depends on resistance desired, that is, the more damper sheets 56 the more resistance. So, this structure can avoid the cover being broken by overturning the display 2 unduly.

Referring back to FIG. 2, as an improvement to the above embodiment, tabs 22 and depressed holes 18 are formed on the display 2 and the corresponding panel of the base unit 1 respectively. In a closed state, the tabs 22 are inserted into the depressed holes 18 to block free rotation of the display 2. The display 2 further forms cushions on the side adjacent to the base unit 1 for avoiding the screen of the display being damaged during rotation. On the top of the display 2 there is a magnet 26 which is across the front and rear surface of the display 2. Correspondingly the base unit 1 forms an iron block to engage with the magnet 26 by magnetism so that the display 2 may rest on the base unit 1. The structure is simple and easy to use.

The horizontal tube 32 of the T-shaped connecting hinge 3 above-mentioned is located on the display 2 to ensure that the display 2 can be rotated along the rotation axis of the horizontal tube 32. The longitudinal tube 34 is located on the base unit 1 to ensure that the display 2 can be rotated along a rotation axis of the longitudinal tube 34. The projection 342 and the protrusion 16 located on the longitudinal tube 34 and the bottom cover 10 respectively can ensure that the rotation will cease after the display 2 is turned to certain angle. In general it is convenient for users to adjust any position of the display 2 so as to obtain preferred visual effect.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A portable disk player comprising:
a base unit defining a disk driven device and a disk read processing device therein, said base unit forming a mounting base on a bottom cover thereof, said mounting base including a protrusion;
a display being pivotally connected with one side of said base unit; and
a connecting hinge connecting said base unit with said display and including a horizontal tube extending horizontally, a longitudinal tube extending longitudinally, said longitudinal tube including a projection;
wherein when said connecting hinge is located in a first position, one side of said projection of said longitudinal tube resists against one side of said protrusion of said mounting base, and when said connecting hinge is located in a second position, the other side of said projection of the longitudinal tube resists against the other side of said protrusion of said mounting base.

2. The portable disk player as claimed in claim 1, wherein said connecting hinge is T-shaped and hollow, and said horizontal tube is mounted onto said display and said longitudinal tube is mounted onto said base unit.

3. The portable disk player as claimed in claim 1, wherein said connecting hinge includes a turnplate located between said horizontal tube and said longitudinal tube, said turnplate further includes a circular slide rail depressed downwardly therefrom and having a pit, there is a hard ball on a surface of said base unit corresponding to the position of said turnplate which can roll in said slide rail and can be locked within said pit.

4. The portable disk player as claimed in claim 1, wherein a damper is formed on one end of said horizontal tube of said connecting hinge, one end of said damper is inserted into said horizontal tube and the other end is fixed on said display.

5. The portable disk player as claimed in claim 4, wherein said damper includes an axis, a mounting sheet for mounting said damper into said connecting hinge, a plurality of damper sheets and a nut.

6. The portable disk player as claimed in 5, wherein one end of said axis is tabular and can be locked into said display, said mounting sheet, damper sheets and nut are hitched onto the other end of said axis in turn and all are arranged in said horizontal tube of said connecting hinge.

7. The portable disk player as claimed in 5, wherein said mounting sheet is L-shaped and has a longitudinal sheet extending longitudinally and a horizontal sheet extending horizontally, said longitudinal sheet is hitched onto said axis and said horizontal sheet is located in a lower portion in said horizontal tube of said connecting hinge.

8. The portable disk player as claimed in 5, wherein each damper sheet is bent to an arc and defines a hole therein, the shape and size of the hole is similar to said axis in corresponding position.

9. The portable disk player box as claimed in claim 5, wherein said nut is a nylon nut of which one end of the screw thread has nylon material.

10. A portable disk player comprising:
a base unit forming a mounting base on a bottom cover thereof, said mounting base including a protrusion; and
a display including a connecting hinge by which said display is pivotally connected with one side of said base unit, said connecting hinge including a horizontal tube extending horizontally and a longitudinal tube extending longitudinally, said longitudinal tube including a projection;
wherein when said connecting hinge is located in a first position, one side of said projection of said longitudinal tube resists against one side of said protrusion of said mounting base, and when said connecting hinge is located in a second position, the other side of said projection of the longitudinal tube resists against the other side of said protrusion of said mounting base.

11. The portable disk player as claimed in claim 10, wherein said connecting hinge is T-shaped and hollow, and said horizontal tube is mounted onto said display and said longitudinal tube is mounted onto said base unit.

12. The portable disk player as claimed in claim 10, wherein said connecting hinge includes a turnplate located between said horizontal tube and said longitudinal tube, said turnplate further includes a circular slide rail depressed downwardly therefrom and having a pit, there is a hard ball on a surface of said base unit corresponding to the position of said turnplate which can roll in said slide rail and can be locked within said pit.

13. The portable disk player as claimed in claim 10, wherein a damper is formed on one end of said horizontal tube of said connecting hinge, one end of said damper is inserted into said horizontal tube and the other end is fixed on said display.

14. The portable disk player as claimed in claim 13, wherein said damper includes an axis, a mounting sheet for mounting said damper into said connecting hinge, a plurality of damper sheets and a nut.

15. The portable disk player as claimed in 14, wherein one end of said axis is tabular and can be locked into said display, said mounting sheet, damper sheets and nut are hitched onto the other end of said axis in turn and all are arranged in said horizontal tube of said connecting hinge.

16. The portable disk player as claimed in 14, wherein said mounting sheet is L-shaped and has a longitudinal sheet extending longitudinally and a horizontal sheet extending horizontally, said longitudinal sheet is hitched onto said axis and said horizontal sheet is located in a lower portion in said horizontal tube of said connecting hinge.

17. The portable disk player as claimed in 14, wherein each damper sheet is bent to an arc and defines a hole therein, the shape and size of the hole is similar to said axis in corresponding position.

18. The portable disk player box as claimed in claim 14, wherein said nut is a nylon nut of which one end of the screw thread has nylon material.

19. A portable disk player comprising:
a base unit defining a disk driven device and a disk read processing device therein, said base unit forming a mounting base on a bottom cover thereof, said mounting base including a protrusion;
a display being pivotally connected with one side of said base unit; and
a connecting means for connecting said base unit with said display and ensuring said display to be rotated along a horizontal and longitudinal axis respectively;
wherein a first position and a second position are predetermined, said display is rotated between said first position and second position.

20. The portable disk player box as claimed in claim 19, wherein said first position and second position predetermined are defined on a horizontal plane.
